(19) United States
(12) Patent Application Publication
(10) Pub. No.: US 2024/0392896 A1
(43) Pub. Date: Nov. 28, 2024

(54) ELEMENTS AND A SEALANT FOR USE AS PART OF A SEALING SYSTEM FOR SEALING OFF A CONDUIT

(71) Applicant: Beele Engineering B.V., Aalten (NL)

(72) Inventor: Johannes Alfred Beele, Aalten (NL)

(73) Assignee: Beele Engineering B.V., Aalten (NL)

(21) Appl. No.: 18/568,073

(22) PCT Filed: Jun. 10, 2022
(86) PCT No.: PCT/NL2022/050324

§ 371 Date: Dec. 7, 2023

(30) Foreign Application Priority Data
Jun. 11, 2021 (NL) 2028436

(51) Int. Cl. F16L 5/04

(52) U.S. Cl. CPC F16L 5/04

(57) ABSTRACT

A plurality of elements of which each element is for use as part of a fire-resistant sealing system for sealing off a conduit by making with the elements a support structure in the conduit and optionally by providing against that support-structure a sealant. Each element is of an elastic material that comprises predominantly fire-resistant rubber. One or more of the elements, and preferably each of the elements, exhibits at room temperature a color that has a calming physiological effect on humans and/or a calming psychological effect on humans. Preferably the optional sealant also exhibits such a color. Even more preferably the optional sealant exhibits the same color.

### INTRODUCTION

The disclosure relates to a plurality of elements of which each element is for use as part of a fire resistant sealing system for sealing off a conduit, and use of such elements, as well as to a sealant.

Constructions have often plate-shaped parts for forming compartments. Through such a plate-shaped part a conduit may be extending and a pipe or cable may extend through the conduit from one of the two compartments into the other. A sealing system is usually applied in the conduit to occupy the remaining space in the conduit and to seal the conduit off.

Such a conduit is often present on board of vessels and/or other offshore applications such as oil rigs. These conduits are often referred to as pipe or cable penetrations or transit systems. These penetrations are seen as unwelcome necessities in such a construction, as these entail introducing “weak spots” in a separation of the compartments.

Pipes for, for instance, water distribution and water wastage systems, air conditioning systems, hydraulic and pneumatic control, sprinkler etc. but also for transport of gas, or oil, need to be extending throughout such a construction. Cables could for instance be electricity cables, but also optical fiber cables, or other cables for communication purposes.

Although above reference is made to a construction element having a conduit and dividing two compartments, it is also possible that the construction element separates a compartment from the surrounding environment. It is thus possible that one side of the construction element is exposed to atmospheric conditions.

Such conduits form weak spots, not so much in terms of the mechanical strength of the construction but much more in the potential of undesired transport of physical phenomena through the conduits, and therewith throughout the structure.

One of these physical phenomena is the occasion of a fire which needs to be confined to only one area for as long as possible, not only to allow for control and extinguishing the fire, but also to provide time for people present in compartments near to the fire for reaching a safe distance from the fire before it further expands. To prevent smoke and/or fire from passing through the conduit from one compartment to another, the conduit is usually provided with a sealing system that closes the conduit, at least for some time, when the conduit is exposed to heat due to a fire.

Such sealing systems are known, for instance from WO 2008/104237 A1 and WO 2019/048691 A1 of the same applicant. In these examples, the system comprises rubber elements which can be inserted in a conduit through which already pipe(s) and/or cable(s) extend, and be placed around the cable(s) and/or pipe(s) in a non-coaxial fashion for filling the remaining space in the conduit. These elements can thus together in the conduit surround the pipe(s) and/or cable(s). If enough elements are inserted into the conduit and are clamped-in, in the conduit, then the elements can together form a stable support structure.

Against the support structure, thus against the elements, a sealant can be applied for sealing off the conduit. It is customary that the sealant is applied at both ends, as it is often not known in advance from which side a fire may approach the conduit. A sealant on both sides also offers the advantage that any air trapped in the conduit contributes to the formation of a barrier for transport of heat through the conduit. However, although not recommended, it is optionally possible to only apply a sealant at one side of the conduit.

Some sealing systems are initially designed and intended for use without a sealant. Then, the clamped-in support structure, as formed by the clamped-in rubber elements are supposed to provide the sealing of the conduit. This can work well if the rubber elements are not pressed up to a point that stress relaxation starts occurring over time.

On the market are however systems in which the rubber elements are mechanically put and kept under pressure by a so-called (com)pression unit. As the rubber is significantly deformed and stress relaxation starts to occur, these sealing systems require a frequent retightening of the elements together by applying more pressure with the compression unit. In essence, the conduit cross-section is made smaller and smaller. At some point in time, further retightening is no longer helpful. The sealing integrity cannot be restored. At the latest at that stage, either the entire sealing system is replaced, or a sealing system including a sealant is applied at least at one end of the conduit, but preferably at both ends. EP 16777617.8 provides further disclosure in relation to such a situation.

### BACKGROUND OF THE DISCLOSURE

In both WO 2008/104237 A1 and WO 2019/048691 A1 is described that a color of the elements and/or of the sealant is preferably contrasting with black as that allows after exposure of one side of the conduit to a nearby fire for a quick identification of the sealing system. It would further allow for assessing the severity of the exposure and for gaining understanding what took place during the fire in terms of thermal exposure. Both WO 2008/104237 A1 and WO 2019/048691 A1 express a further preference for red-brown, like terracotta, as this color is easily traced back even in a partly blackened and fully burned out compartment.

Whilst these advantages are generally worth having, there is a need to further optimise a colour of such a sealing system, so that advantages of a color are also experienced before inspection of a sealing system that has been exposed to a nearby fire.

It is an object of the disclosure to meet the above described need.

### SUMMARY OF THE DISCLOSURE

According to one aspect of the disclosure there is provided a plurality of elements of which each element is for use as part of a fire resistant sealing system for sealing off a conduit by making with the elements a support structure in the conduit and optionally by providing against that support-structure a sealant, wherein each element is of an elastic material that comprises predominantly rubber, and wherein at least one of the elements, and preferably each of the elements, exhibits at room temperature a color that has a calming physiological effect on humans and/or a calming psychological effect on humans. Preferably, the sealant also exhibits such a color. Even more preferably, the sealant exhibits the same color as that of the elements.

Before inspection of elements of the sealing system after exposure to a nearby fire, the elements of a sealing system have gone through at least three well-distinguishable periods of time. First there is the period of installation. After that, there is a period of use without exposure to a nearby fire. Then, in case of unfortunate developments that include a fire, there is a period of exposure to a nearby fire.

A sealing system needs to be installed by a worker having the rights skills and having the right mentality to apply good care. However, as this is normally taking place in a budget-controlled setting, there will also be some time pressure to get the job done. This is a very critical period, as no matter how good a sealing system can be, an incorrect installation may undermine its performance. When the state of mind and/or the state of the body of the worker is/are at ease, the worker may more likely apply his skills optimally and exercise care to not make any mistake during the installation.

During the time that a sealing system has been installed and is not exposed to a nearby fire, the properties of the installed sealing system are ideally maintained. At that stage, a color if visible and signalling its presence, and having a calming physiological effect and/or a calming psychological effect on humans, has the advantage that further work in close proximity of the sealing system is likely to also be carried out with knowledge about the presence of the sealing system. A worker is likely to calmly carry out his job, knowing that an installed sealing system is nearby, and that none of his activities should negatively affect the immediate and long-term integrity of the sealing system.

For a period of time that exposure to a nearby fire takes place, two different areas need to be considered. One area is on the side that is nearest to the fire, referred to as the exposed side, and the other side is at the side that is further away from the fire, referred to as the unexposed side. The color of the elements of the sealing system will start changing at the exposed side at a temperature which humans will not be able to withstand. Over time, if the exposure to a nearby fire will continue to take place, the color of the entire length of the elements might change throughout the conduit from the exposed side to the unexposed side.

If visible, this has a signalling effect to the extent that the original colour, chosen to have a calming physiological effect and/or a calming psychological effect on humans, will no longer be exhibited on the unexposed side. It signals that the fire has continued and that the sealing system has changed. That is advantageous because humans on that unexposed side of the sealing system should be alarmed and energized to take appropriate action, for instance by extinguishing the fire or by trying to seek a route to safer positions and escape from the heated and very endangered area.

Advantageously, the color can thus be such that it has advantages for the installing and the performance of the sealing system so as to ensure that the sealing system is up to do its job when exposed to a fire, and such that humans consciously or subconsciously experience useful assistance from the color of elements of the sealing system, throughout the most relevant part of the life-time of the sealing system.

### In an Embodiment, the Color is a Pastel Color

Pastel colors are considered to pertain to kindness, gentleness, and sensitivity, enhancing thus the chance that the elements of the sealing system are treated accordingly. Notably, the application of sealing systems is sensitive to an incorrect application and to an unkind deliberate misplacement. A gentle approach when applying a sealing system is better than a careless uncontrolled application of forces, as this could lead to a high concentration of stress. In turn this could lead to stress relaxation and creep phenomena, which would both overtime undermine the qualities of a sealing system. Installing elements as part of a sealing system with an attitude of kindness to the sealing system whilst having a mind and use of fingers sensitive to detecting stress raisers, or weak spots, is helpful for installing the sealing system optimally.

Advantageously, pastel colors are the result of tinting colourful tints with white. As a result, pastel colors reflect more light, and consequently, have a reduced absorbance of light of all wavelengths, so that light is less likely to affect properties of the material, enhancing the lifetime of at least some of the qualities of the rubber of the elements.

At the same time, pastel color elements still have a color that can be used for other purposes, during later periods of time which the elements may experience.

On exposure to a nearby fire pastel colors are likely to reflect heat better than other non-white colours.

### In an Embodiment, the Color is a Green Color

The color green is perceived to be relating to balance and harmony. It is believed to have a relaxing effect on humans. This color appears particularly suitable for installing a sealing system, in which an inhomogeneous distribution of stress is to be avoided and in which instead balance and harmony needs to be pursued. Having the elements in a color that is likely to bring the mindset of a worker in a very suitable condition for installing, contributes to the likelihood that the sealing will be well-installed and that the sealing will accordingly perform as intended.

Throughout the lifetime of the elements up to exposure to a nearby fire, a green colour provides a strong signal that a crucial sealing system is present and that some caution needs to be taken not to damage the sealing system. At the same time, the color is not overly strong in its signal, and is for instance unlikely to be picked up as a signal that it is forbidden to lead another cable through the conduit and then re-seal the conduit.

In case of exposure to a nearby fire, green will, as long as it remains green, signal that the fire has not managed to work its way to the side of the conduit at which the elements are still green.

### In an Embodiment, the Color is a Pastel Green Color

Pastel green is thought to help promote a sense of serenity and help balance emotions; pastel green's gentle appearance makes it a particularly calming shade. This is even more likely to bring a worker in a mental condition that is very suitable for calmly and in a balanced way installing the sealing system.

Furthermore, pastel green is through the lifetime of the sealing system a color that is unlikely to trigger unbalanced emotions and as such it appears to be a “safe” color.

A pastel green color protects itself to an extent against heating up in case of a nearby fire due to its reflectivity. In any case, a pastel green color will be better than most, if not all, other green colours, when it comes to reflectivity.

In an embodiment, each element is a longitudinal element. Such an element allows for placement in the conduit in an orientation parallel to an axial direction of the conduit and parallel to an axial direction to any cables and/or pipes extending through the conduit. When many of the elements are clamped-in in such a fashion in the conduit, frictional forces that need to be overcome for destabilizing up to removing out of the conduit the clamped-in support structure, are extremely high.

In an embodiment, each element is free of a flange. This allows for a full insertion of the elements into a conduit as no flange can be abutting an outer rim of the conduit and as such hamper a further and full insertion of that element in the conduit. By producing or chopping the elements in a size so that the elements can be fully inserted into the conduit and at least at one end of the conduit further than the rim of the conduit, a sealant can be applied against the clamped-in elements and be made flush with the rim of the conduit. As such that sealant is to an extent mechanically protected by the conduit and the sealant can adhere to an inner wall of the conduit and thus seal-off that end of the conduit.

In an embodiment, each element is a tubular element having a hollow core, or is such that a number of the elements can together form one tubular element having a hollow core. These elements are ideally applied in combination with a sealant for sealing off at least at one end of the conduit. The sealant can be pressed into the openings formed by the stacked elements, and as such have a good “grip” onto the support structure and more surface area for adhering to the support structure.

In an embodiment, each element is cylindrical in shape. This allows for easy placement, but also for selectively pulling out of the clamped-in stack of elements. This is helpful, for instance for pulling an additional cable though the conduit and sealing off again, without having to remove the entire sealing system first.

In an embodiment, each element is formed out of an extrudate. This allows for fast and cost-effective production of the elements, at short notice, making the elements very suitable for responding to sudden needs which might be caused by disasters, accidents, catastrophes etc.

In an embodiment, each element elements is formed by injection moulding. This allows for relatively rapidly producible elements, of a reasonable size.

In an embodiment, each element is formed by compression moulding. This allows for making very large elements.

In an embodiment, each tubular element has an inner diameter in a range of 8 to 40 millimetres, preferably in a range of 10 to 32 millimetres.

In an embodiment, each tubular element has an outer diameter in a range of 16 to 50 millimetres, preferably in a range of 20 to 40 millimetres.

In an embodiment, each tubular element has a mantle wall having a thickness of about 3 to 7 millimetres, preferably between 4 to 6 millimetres.

In an embodiment, the rubber has a hardness in a range of 70 to 79 Shore A, preferably in a range of 72 to 77 Shore A.

In an embodiment, one and preferably each element is free from foam, so that the rubber can be provided without incorporating a foaming agent.

In another embodiment, one, and preferably each, element comprises a foam, or is made of a foam. The element can function as very good barrier for transfer of heat. Foam has extremely good heat insulating properties.

In an embodiment, the foam comprises cells, of which preferably more than 60% are closed cells. This further improves the heat barrier function of the respective element.

In an embodiment, the rubber is a silicone rubber. Advantageously, such rubbers are in its pure form available in color that can be described as “milky white”, and allow for mixing in pigments in high level batches. This allows for making excellent use of properties of a color or making use of predetermined associations of a color.

In an embodiment, the rubber is a ceramifiable rubber. As known, ceramifiable rubber can be based on polymers with a high amount of mineral fillers. Ceramifiable rubber, i.e. rubber that turns under exposure to fire into a ceramic, has been used for producing fire-resistant electrical cables. A relatively thin mantle filled with mineral fillers can still just about remain flexible enough at room temperature. Such thin layers can just about be extruded and then be vulcanized. The thin layer of rubber is kept in its extruded shape by the core of the cable, namely the electrically conducting cable which is often of copper. Surprisingly, elements of a sealing system that will need to absorb mechanical forces, and that therefore need to have sufficient thickness and/or a shape that can distribute those forces can also be of a ceramifiable rubber.

According to another aspect of the present disclosure a fire retardant sealant is provided for use as part of a fire resistant sealing system for sealing off a conduit by providing a support structure in the conduit using rubber elements and by providing the sealant against that support-structure, wherein the sealant vulcanizes into rubber that exhibits at room temperature, and before and after vulcanization, a color that has a calming physiological effect on humans and/or a calming psychological effect on humans.

In analogy to the advantages above outlined for elements of the sealing system, before inspection of possible remainders of the sealant of the sealing system after exposure to a nearby fire, the sealant of a sealing system has gone through at least three well-distinguishable periods of time. First there is the period of installation. After that, there is a period of use without exposure to a nearby fire. Then, in case of unfortunate developments that include a fire, there is a period of exposure to a nearby fire.

A sealing system needs to be installed by a worker having the rights skills and having the right mentality to apply good care. However, as this is normally taking place in a budget-controlled setting, there will also be some time pressure to get the job done. This is a very critical period, as no matter how good a sealing system can be, an incorrect installation may undermine its performance. When the state of mind and/or the state of the body of the worker is/are at ease, the worker may more likely apply his skills optimally and exercise care to not make any mistake during the installation.

During the time that a sealing system has been installed and is not exposed to a nearby fire, the properties of the installed sealing system are ideally maintained. At that stage, a color if visible and signalling its presence, and having a calming physiological effect and/or a calming psychological effect on humans, has the advantage that further work in close proximity of the sealing system is likely to also be carried out with knowledge about the presence of the sealing system. A worker is likely to calmly carry out his job, knowing that an installed sealing system is nearby, and that none of his activities should negatively affect the immediate and long-term integrity of the sealing system.

For a period of time that exposure to a nearby fire takes place, two different areas need to be considered. One area is on the side that is nearest to the fire, referred to as the exposed side, and the other side is at the side that is further away from the fire, referred to as the unexposed side. The color of the sealant of the sealing system will start changing at the exposed side at a temperature which humans will not be able to withstand. Over time, if the exposure to a nearby fire will continue to take place, the color of the sealant applied at the unexposed side might change.

If visible, this has a signalling effect to the extent that the original colour, chosen to have a calming physiological effect and/or a calming psychological effect on humans, will no longer be exhibited on the unexposed side. It signals that the fire has continued and that the sealing system has changed. That is advantageous because humans on that unexposed side of the sealing system should be alarmed and energized to take appropriate action, for instance by extinguishing the fire or by trying to seek a route to safer positions and escape from the heated and very endangered area.

Advantageously, the color can thus be such that it has advantages for the installing and the performance of the sealing system so as to ensure that the sealing system is up to do its job when exposed to a fire, and such that humans consciously or subconsciously experience useful assistance from the color of the sealant of the sealing system, throughout the most relevant part of the life-time of the sealing system.

### In an Embodiment, the Color is a Pastel Color

Pastel colors are considered to pertain to kindness, gentleness, and sensitivity, enhancing thus the chance that the elements of the sealing system are treated accordingly. Notably, the application of sealing systems is sensitive to an incorrect application and to an unkind deliberate misplacement. A gentle approach when applying a sealant is better than a careless uncontrolled application of forces. The sealant needs to be applied with accuracy, homogeneously, and without a lack of coverage.

Advantageously, pastel colors are the result of tinting colourful tints with white. As a result, pastel colors reflect more light, and consequently, have a reduced absorbance of light of all wavelengths, so that light is less likely to affect properties of the material, enhancing the lifetime of at least some of the qualities of the rubber of the elements.

At the same time, pastel color elements still have a color that can be used for other purposes, during later periods of time which the elements may experience.

On exposure to a nearby fire, pastel colors are likely to reflect heat better than other non-white colours.

### In an Embodiment, the Color is a Green Color

The color green is perceived to be relating to balance and harmony. It is believed to have a relaxing effect on humans. This color appears particularly suitable for installing a sealant, for which balance and harmony needs to be pursued. Having the sealant in a color that is likely to bring the mindset of a worker in a very suitable condition for applying, contributes to the likelihood that the sealing will be well-applied and that the sealing will accordingly perform as intended.

Throughout the lifetime of the elements up to exposure to a nearby fire, a green colour provides a strong signal that a crucial sealing system is present and that some caution needs to be taken not to damage the sealing system. At the same time, the color is not overly strong in its signal, and is for instance unlikely to be picked up as a signal that it is forbidden to lead another cable through the conduit and then re-seal the conduit.

In case of exposure to a nearby fire, green will, as long as it remains green, signal that the fire has not managed to work its way to the side of the conduit at which the elements are still green.

### In an Embodiment, the Color is a Pastel Green Color

Pastel green is thought to help promote a sense of serenity and help balance emotions; pastel green's gentle appearance makes it a particularly calming shade. This is even more likely to bring a worker in a mental condition that is very suitable for calmly and in a balanced way installing the sealing system. Particularly an end stage of applying the sealant, the worker often will need to use his hands and fingers to ensure that sealant is firmly pressed against, and if possible partly into, the support structure as formed by the elements of the sealing system. Furthermore, pastel green is through the lifetime of the sealing system a color that is unlikely to trigger unbalanced emotions and as such it appears to be a “safe” color.

A pastel green color protects itself to an extent against heating up in case of a nearby fire due to its reflectivity. In any case, a pastel green color will be better than most, if not all, other green colours, when it comes to reflectivity.

### SHORT DESCRIPTION OF THE DRAWING

To enable better understanding of the present disclosure, and to show how the same may be carried into effect, reference will now be made, by way of example only, to the accompanying drawings, in which:

FIG. 1 shows a plate-shaped construction element (partly cut away for providing more sight) having a conduit extending therethrough and a plurality of elements of which each element is for use as part of a sealing system for sealing off the conduit wherein the plurality of elements is according to the disclosure;

FIG. 2 shows one element of an example of a plurality of elements according to the disclosure;

FIG. 3 shows a front view of another conduit having a plurality of elements according to the present disclosure;

FIG. 4 shows the conduit of FIG. 3 in perspective and only half filled with a plurality of elements according to the disclosure;

FIG. 5 shows another plate-shaped construction element (partly cut away for providing more sight) having another conduit extending therethrough and another and a plurality of elements of which each element is for use as part of a sealing system for sealing off the conduit wherein the plurality of elements is according to the disclosure;

FIG. 6 shows the same a FIG. 5 and an optional sealant provided for providing against the plurality of elements; and

FIG. 7 shows in cross-section s plate-shaped construction element having a conduit extending therethrough and a plurality of elements according to the present disclosure places therein, and a layer of sealant provided against the plurality of elements.

### DETAILED DESCRIPTION OF THE DISCLOSURE

In the drawing and the description of the drawing, like-parts have like-references.

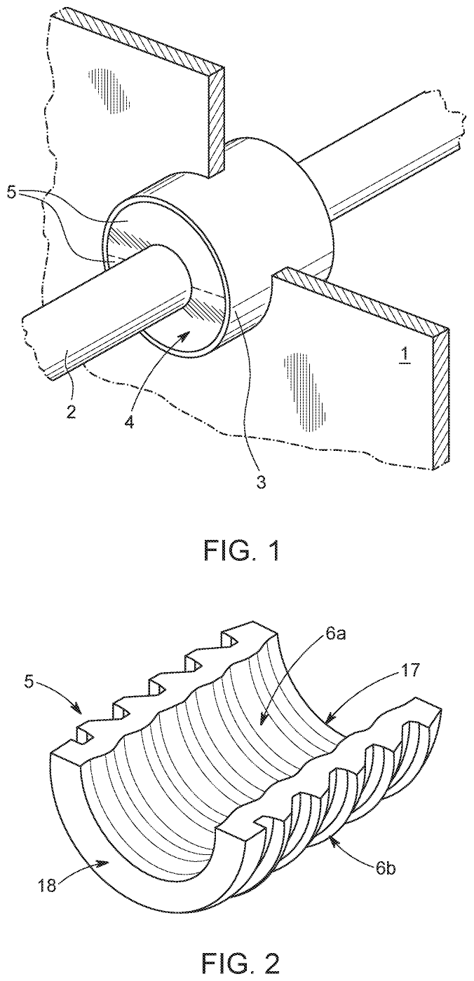

FIG. 1 shows a plate-shaped construction element 1 that functions as a divider between compartment I and II. A pipe 2 extends from compartment I into compartment II, through the construction element 1. For that purpose, a conduit 3 is positioned so that the pipe 2 can extend through the conduit 3. An outer wall of the conduit 3 may be welded against a rim of an opening in the plate-shaped construction element, but may also be bolted against the plate-shaped construction element. Mounting a conduit such that it seals off any possible gap between the conduit 3 and the plate-shaped construction element 1 is not a problem for those skilled in the art, is a routine activity and not a focus of the present disclosure.

In the conduit 3 one can see a plurality of elements (two in this example) of which each element is for use as part of a sealing system 4 for sealing off the conduit 3 by providing a support structure in the conduit 3 using the plurality of elements 5. The example of FIG. 1 shows two elements 5. Each element 5 is of an elastic material that comprises predominantly rubber. Preferably, at least one of the elements 5 and even more preferably each element 5 is a longitudinal element of which an example is shown in FIG. 2. Preferably, and as shown, each element 5 is free of a flange. The longitudinal element shown in FIG. 2 is one half of a sealing, having inner ribs 6, outer ribs 7, a distal end 17 and a proximal end 18. The half plug 5 can be inserted, ideally together with another half plug, into an annular space that is formed in the conduit between an inner wall of the conduit and the pipe 2. During insertion, the distal end 17 is inserted first, and the pressure is applied against the proximal end 18 to fully insert the plug part.

At least one of the elements 5, and preferably, each of the elements 5, exhibits at room temperature a color that has a calming physiological effect on humans and/or a calming psychological effect on humans.

Before focusing in this description further on the drawing, an explanation will be provided as to how features that are not easily displayed in a drawing but still part of this disclosure, can be obtained.

A color that has a calming physiological effect on humans is most likely such a feature. Also a color that has a calming psychological effect on humans is probably such a feature.

For centuries, it has been known, even though it had for a long time not scientifically been proven, that color can create physiological effects and can create psychological effects. Physiological effects create a change in the body whilst psychological effects create a change in the mind.

The physiological mechanisms that underpin human color vision have been understood for the best part of a century, but only in the last couple of decades has been discovered and up to an extent been understood that there is a separate mechanism for non-visual effects of color. Like the ear, which allows humans to detect sound within a certain frequency, and provides humans additionally with a sense of balance, it is now known that also the eye performs multiple functions.

Light sensitive cells known as cones in the retina at the back of the eye send electrochemical signals primarily to an area of the brain known as the visual cortex, where the visual images we see are formed. However, it is now known that some retinal ganglion cells respond to light by sending signals mainly to a central brain region called the hypothalamus which plays no part at all in forming visual images.

The hypothalamus is a key part of the brain responsible for the secretion of a number of hormones which control many aspects of the body's self-regulation, including temperature, sleep, hunger and other rhythms that relate to the 24 hour cycle.

The retinal cells form a pathway between the human eye and the hypothalamus. The cells are selectively sensitive to the short wavelengths of the visible spectrum, i.e. blue and green. It follows that there clearly is an established physiological mechanism through which colours like blue and green can affect heart rate, alertness, and mood, to name a few.

Psychological effects are sensed in mind. Previous experiences and/or learned behaviour may determine to a extent how people react a color. However, as a number of experiences are universal, the reactions tend to be universal too. The association of colors with our emotions may stem from the fact that emotions and color vision are both processes which occur in the right hemisphere of the human brain.

Without wishing to be bound by any theory, in general, it is believed that colors which are in nature non-threatening are physically soothing and may simultaneously produce an emotional lift.

### The Color of Each of the Plurality of Elements 5 May be a Green Colour.

Green is the color which is most associated with nature. People tend to experience exposure to green as relaxing and refreshing. Green is a soothing, peaceful color.

In color psychology, green is thought to help promote a sense of serenity and help balance emotions. Indeed, there are many observations which suggest that green has a calming effect, helping to concentrate on a task.

### The Color of Each of the Plurality of Elements 5 May be a Pastel Colour.

Pastel colors can be obtained by “adding white to a colour”. It not only increases the colour's reflectivity, pastel colors are particularly soothing and thus suitable for calming a human.

The color of each of the plurality of elements may be a green pastel color. Pastel green's gentle appearance makes it a particularly calming shade. Pastel green's subdued appearance makes it easy on the eyes and suitable for use in large amounts. It further promotes relaxation or associations with health and freshness.

Pastels or pastel colors belong to a pale family of colours, which, when described in the HSV color space, have high value and low to intermediate saturation.

Colours are ideally quantifiable, so as to check on reproducibility and as guidance for making a color on the basis of using other colours.

In the following, some color models are discussed, as an introduction to what is referred to as a HSV color space, which is very suitable for describing pastel colours.

The RGB (red, green, blue) color model is the most well-known way to mix and create colours. Commercial printers, may use CMYK (cyan, magenta, yellow, key). Graphics software tend to use HSV (hue, saturation, value). These are all schemes that describe the way colours combine to create the spectrum we see.

Unlike RGB and CMYK, which use primary colours, HSV is closer to how humans perceive colour. It has three components: hue, saturation, and value. This color space describes colours (hue or tint) in terms of their shade (saturation or amount of gray) and their brightness value. Some color pickers, like the one in Adobe Photoshop, use the acronym HSB, which substitutes the term “brightness” for “value,” but HSV and HSB refer to the same color model.

The HSV color wheel sometimes appears as a cone or cylinder, but always with these three components:

Hue is the color portion of the model, expressed as a number from 0 to 360 degrees:
Red falls between 0 and 60 degrees.
Yellow falls between 61 and 120 degrees.
Green falls between 121-180 degrees.
Cyan falls between 181-240 degrees.
Blue falls between 241-300 degrees.
Magenta falls between 301-360 degrees.

Saturation describes the amount of grey in a particular colour, from 0 to 100 percent. Reducing this component toward zero introduces more grey and produces a faded effect. Sometimes, saturation appears as a range from just 0-1, where 0 is grey, and 1 is a primary colour.)

Value (or Brightness) works in conjunction with saturation and describes the brightness or intensity of the colour, from 0-100 percent, where 0 is completely black, and 100 is the brightest and reveals the most color.

Designers use the HSV color model when selecting colors for paint or ink because HSV better represents how people relate to colors than the RGB color model does.

The HSV color wheel also contributes to high-quality graphics. Although less well known than its RGB and CMYK cousins, the HSV approach is available in many high-end image editing software programs.

Selecting an HSV color begins with picking one of the available hues and then adjusting the shade and brightness values.

Pastel colors may also be expressed in the HEX code, which is a conversion of the RGB code. Conversion tables are widely available on the internet.

Pastel Green is in the HEX Code Referred to as #77dd77

In a RGB color space (made from three coloured lights for red, green, and blue), hex #77dd77 is made of 46.7% red, 86.7% green and 46.7% blue. In a CMYK color space (also known as process colour, or four colour, and used in color printing), hex #77dd77 is made of 46% cyan, 0% magenta, 46% yellow and 13% black. Pastel Green has a hue angle of 120 degrees, a saturation of 60% and a lightness of 66.7%.

The following table shows some additional ways of expressing pastel green

| | VALUE | CSS |
|---|---|---|
| HEX | 77dd77 | #77dd77 |
| RGB DECIMAL | 119, 221, 119 | rgb(119, 221, 119) |
| RGB PERCENTAGE | 46.7, 86.7, 46.7 | rgb(46.7%, 86.7%, 46.7%) |
| CMYK | 46, 0, 46, 13 | |
| HSL | 120°, 60, 66.7 | hsl(120°, 60%, 66.7%) |
| HSV (OR HSB) | 120°, 46.2, 86.7 | |
| WEB SAFE | 66cc66 | #66cc66 |
| CIE-LAB | 80.159, −50.083, 40.913 | |
| XYZ | 36.792, 56.964, 26.506 | |
| XYY | 0.306, 0.474, 56.964 | |
| CIE-LCH | 80.159, 64.67, 140.754 | |
| CIE-LUV | 80.159, −48.186, 62.292 | |
| HUNTER-LAB | 75.475, −41.687, 28.975 | |
| BINARY | 01110111, 11011101, 01110111 | |

Other ways of expressing the color Green in codes may be as follows.

| HTML/CSS | Hex Code | Decimal Code |
|---|---|---|
| Color Name | #RRGGBB | (R, G, B) |
| lawngreen | #7CFC00 | rgb(124, 252, 0) |
| chartreuse | #7FFF00 | rgb(127, 255, 0) |
| limegreen | #32CD32 | rgb(50, 205, 50) |
| lime | #00FF00 | rgb(0.255.0) |
| forestgreen | #228B22 | rgb(34, 139, 34) |
| green | #008000 | rgb(0, 128, 0) |
| darkgreen | #006400 | rgb(0, 100, 0) |
| greenyellow | #ADFF2F | rgb(173, 255, 47) |
| yellowgreen | #9ACD32 | rgb(154, 205, 50) |
| springgreen | #00FF7F | rgb(0, 255, 127) |
| mediumspringgreen | #00FA9A | rgb(0, 250, 154) |
| lightgreen | #90EE90 | rgb(144, 238, 144) |
| palegreen | #98FB98 | rgb(152, 251, 152) |
| darkseagreen | #8FBC8F | rgb(143, 188, 143) |
| mediumseagreen | #3CB371 | rgb(60, 179, 113) |
| lightseagreen | #20B2AA | rgb(32, 178, 170) |
| seagreen | #2E8B57 | rgb(46, 139, 87) |
| olive | #808000 | rgb(128, 128, 0) |
| darkolivegreen | #556B2F | rgb(85, 107, 47) |
| olivedrab | #6B8E23 | rgb(107, 142, 35) |

In the context of this disclosure “pastel green” embraces green colors referred to as springgreen, mediumspring green, lightgreen and palegreen. In the context of the present disclosure also the following color codes are considered to be embraced by the term pastel green: #91dd77 rgb (145,221,119); #88dd77 rgb (136,221,119); #80dd77 rgb (128,221,119) #77dd80 rgb (119,221,128); #77dd88 rgb (119,221,136); #77dd91 rgb (119,221,145).

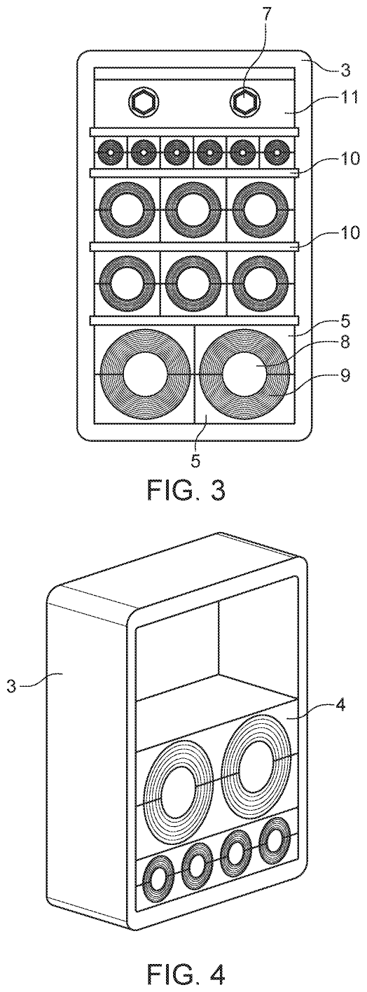

Reference is now made to FIG. 3, which shows a front view of another type of conduit 3, which may also be referred to as a conduit-frame 3. Another type of a plurality of elements 5 is placed in the conduit 3, and a compression unit 11 is positioned high-up in the conduit 3 which is more a conduit-frame 3. The purpose of the compression unit 11 will be explained below. FIG. 4 shows the conduit-frame 3 of FIG. 3 in a perspective view, only half-filled with elements 5, and without the compression unit. This type of conduit-frame 3 with these type of elements 5 therein is often referred to as a Multi Cable Transit, or in short MCT. In essence, the elements 5, as shown, comprise multiple sets of sealing systems 4. Each sealing system 4, as shown in FIGS. 3 and 4 comprises two elements 5. These two elements 5 form together a block-shaped sealing system 4 that is suitable for having one cable (not shown) extending therethrough. The upper block-shaped sealing system allows for two cables to be embraced. The block-shaped sealing system 4 based on the two elements 5 is rectangular in form. Each block-shaped sealing system 4 as shown, comprises a rubber core 8, which will be removed when a cable is to be placed through the conduit-frame 3 at about the position of a respective sealing system 4. The two elements 5 of the respective sealing system 4 will be placed around the cable, and form together the block-shaped sealing system 4. Each element 5 is provided with peelable layers 9 that can be removed for ensuring that a cable with a diameter that is slightly thicker than the diameter of the removed rubber core 8 can also be sealingly embraced by the two halves, without having to depart from the dimensions and shape of the respective block-shaped sealing system 4. The block-shaped sealing system 4 having the same dimensions are placed in a row and then together snugly fit in the conduit 3. From FIG. 4 is clear that the elements 5 extend in a direction that coincides with a direction of cables that may extend through the conduit-frame 3.

On top of the row of sealing systems 4, a stay plate 10 may be placed for a purpose that is explained below. Another row of sealing systems 4 may be placed on top of the stay plate 10. This row may contain block-shaped sealing systems 4 of a different dimension, but still so that the number of block-shaped sealing systems in that row still together snugly fit in the conduit. On top of that row another stay plate may be placed. The conduit 3 may be filled-up in this fashion, up to a level that a compression unit 11 can be fitted (if that has not been provided upfront within the conduit). The compression unit has screws 7 which can be tightened for applying a pressure downwardly onto the stacked sealing systems. The way such a compression unit works is beyond the scope of this disclosure. The stay plates 10 are meant to distribute the “compression” from the compression unit 11.

Also such a MCT is thus provided with elements, which are free of a flange. A number of the elements 5 can together form one tubular element having a hollow core. Each element 5 is cylindrical, in the sense that the cross-section does not change in one direction of the element.

Each element 5 is for use as part of a sealing system 4 for sealing off a conduit 3 by providing a support structure in the conduit using the plurality of elements 5, wherein each element 5 is of an elastic material that comprises predominantly rubber. At least one of the elements 5, and preferably each of the elements 5, may exhibit at room temperature a colour that has a calming physiological effect on humans and/or a calming psychological effect on humans. The color may be a pastel colour, a green color or a green pastel color.

For obvious reasons, given that the compression over time will lead to stress relaxation, and/or creep phenomena that result in a change of the dimensions of the sheathing of the cables, the sealing integrity of an MCT as shown in FIG. 3 tends to deteriorate over time and may start leaking.

Then, a sealant may be applied against the sealing systems 4 as shown in FIGS. 3 and 4, and/or as explained in European Patent Application no. 16777617.8, incorporated herein by reference.

Also the sealant may exhibit a color close to the one as chosen for the elements 5, and preferably the sealant exhibits the same color as the color that is exhibited by the elements 5.

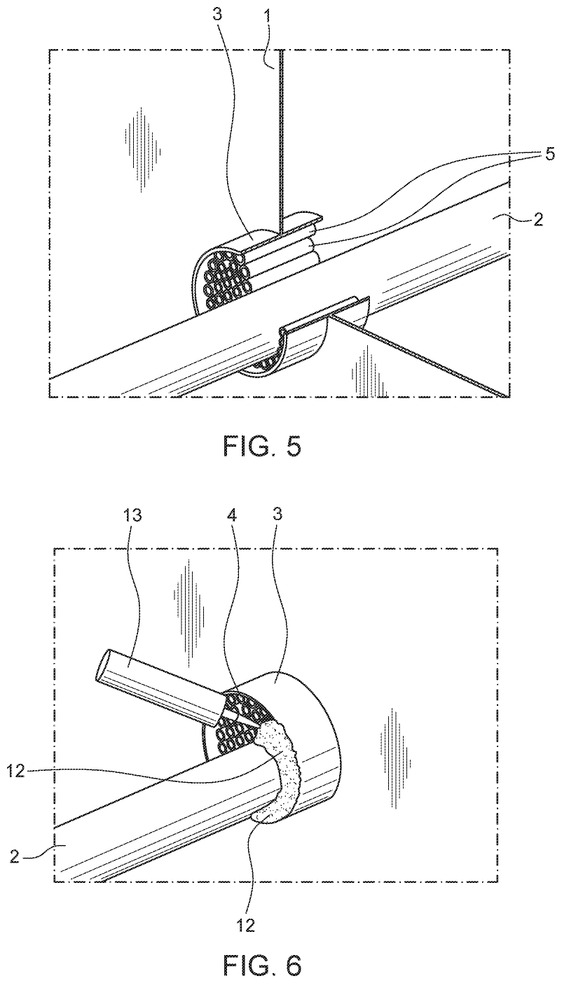

FIG. 5, shows another shows another plate-shaped construction element 1 (partly cut away for providing more sight) having another conduit 3 extending therethrough and another plurality of elements 5 of which each element 5 is for use as part of a sealing system 4. The elements 5 here are like the sleeves shown in WO 2008/104237 A1 and WO 2019/048691 A1, both incorporated herein by reference. In more detail, at least one of the elements and preferable each element 5 is a longitudinal element. Each element 5 is preferably free of a flange. Each element 5 is preferably a tubular element 5 having a hollow core, or wherein a number of the elements 5 can together form one tubular element having a hollow core (not shown). Each element 5 is preferably cylindrical. Each element 5 may be formed from an extrudate, may be formed by injection moulding, or by compression moulding.

Preferably, each element 5 has an inner diameter in a range of 8 to 40 millimetres, preferably in a range of 10 to 32 millimetres. Further, each tubular element 5 may have an outer diameter in a range of 16 to 50 millimetres, preferably in a range of 20 to 40 millimetres. Each tubular element 5 may further have a mantle wall having a thickness of about 3 to 7 millimetres, preferably between 4 to 6 millimetres. The tubular elements 5 may have a longitudinal slit, allowing for placing the tubular element around a cable. The edges of the slit may overlap each other, so that one type of slit may be suitable for cables having a diameter within a certain range. Although it is advantageous to have a number of the elements 5 bonded together into a unit, most of the elements 5 may be separate individual elements. EP 2 116 280 A1 provides further disclosure of such elements 5, therein referred to a sleeves.

The rubber may have a hardness in a range of 70 to 79 Shore A, preferably in a range of 72 to 77 Shore A. This can be achieved by routine experimenting with appropriate (mineral) additives.

FIG. 6 shows the same as FIG. 5 with additionally an optional sealant 12 as provided for providing against the plurality of elements 5 as placed to form together a clamped-in support structure in the conduit 3. As shown, the sealant may be provided by way of a cartridge 13, which is well known in the art.

Each and preferably all of the elements 5 exhibit at room temperature a color that has a calming physiological effect on humans and/or a calming psychological effect on humans. If a sealant 12 is provided then the sealant preferably also exhibits such a colour, and even more preferably the same color as the elements 5 exhibit.

Ideally, the sealant is applied at both ends of the conduit 3, although the conduit 3 can be considered sealed off when at only one end of the conduit 3 sealant 12 is applied.

The color is preferably a pastel color and/or a green color. This applies to the elements, and preferably also to the sealant, if provided.

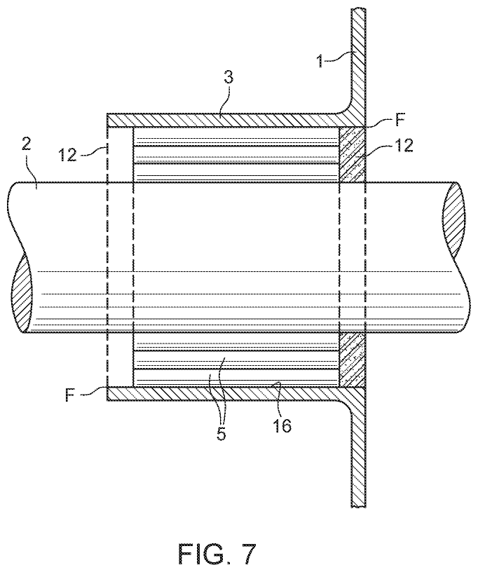

FIG. 7 shows in cross-section a plate-shaped construction element 1 having a conduit 3 extending from the plate-shaped construction element 1. A pipe 2 extends through the conduit 3. A plurality of rubber elements 5 are placed within the inner wall 16 of the conduit 3 and the pipe 2. A layer of sealant 12 is provided against the plurality of elements 5 at an of the conduit 3. In this example, the sealant 12 is flush with plate-shaped construction element 1, as shown at a position marked F. However, as in reality it is unknown from which end 14, 15 a fire approaches a sealed conduit 3, ideally at both ends of the conduit 3 a sealant 12 is provided against the plurality of elements 5.

Although a pipe 2 is shown to extend through the conduit 3 shown in FIGS. 1, 5, 6 and 7, it is possible that multiple pipes are extending through the conduit. Further, instead of pipes, it is possible, and in reality more frequently the case, that cables extend though such a conduit 3.

The rubber of each of the elements 5 of this disclosure is preferably a silicone rubber, which is available in a milky white color. By suitably adding pigments to high level batches a green silicone rubber can be obtained.

Most of the fire-retardant minerals are available in the form of white powder, so that mixing these powders in the high level batch leads to a silicone rubber having a green pastel colour. This enhances the light reflectivity of the rubber.

Even when the silicone rubber is purely green due to high batch level mixing in of pigments and not adopting a pastel green color after mixing in mineral additives, once the heating of the silicon rubber takes place in the presence of oxygen, extremely fine SiO2 powder in a milky white color is eventually formed on the surface of the rubber, so that at the latest then a pastel green color is formed. This enhances then the reflectivity. Accordingly, the green silicone rubber is at relatively low temperature predominantly having an effect on humans based on its greenness. As the rubber is heated, for instance due to a nearby fire, the rubber adopts a pastel green color and finally turns into a soft white, then even better reflecting light.

Ceramifiable rubber can be developed not only on the basis silicone rubber, but also on the basis of more common, organic polymers, Such ceramification is held at least partly responsible for the fire retardancy. Provided that a significant amount of additives for promoting ceramification is used, the ceramification is known to occur in polyethelene and poly (vinyl-acetate)-based and unsaturated polyester-based fire barrier composites. Also ceramifiable styrene-butadiene rubber (SBR), poly (ethylene-vinyl acetate) (EVA) and EVA/PDMS-based composites can be made.

Ceramifiable silicone rubber-based composites are nowadays widely and commonly used in cable industry as a covering material for copper core protection in case of a fire. Such covers are being extruded and once in the desired extruded shape being vulcanized. Moisture in the air is used for providing sites for the formation of a network structure, known as cross-linking. Unique to a one-component system is that the cure to the cross-linked structure is initiated by an external airborne substance (moisture) which means that the degree of cure obtained is dependent on the silicone's cross-sectional thickness. A thickness of a few millimetres is considered to be a limit, as the cure time increases with the thickness.

The disclosure is not limited to what has been shown and discussed above. Although reference is made to a rubber and a use of the elements in fire retardant sealing systems, the elements may also be applied as a gap seal, in on-shore and/or off shore constructions such as for instance tunnels. The sealing of a conduit can take place when the conduit has one or more pipes extending through the conduit, but also when the conduit has one or more cables extending through the conduit.

The purpose of the sealing systems may indeed be to inhibit the spread of a fire, but additionally or alternatively, also to inhibit the spread of the ingress of water, and/or the spread of dynamically occurring loads resulting from water pressure, explosions, vibrations, (re-) settlements, etc.

### The Following Numbered Paragraphs Provide Further Disclosure

1 A plurality of elements of which each element is for use as part of a fire resistant sealing system for sealing off a conduit by providing a support structure in the conduit using the plurality of elements and optionally by providing a sealant against that support-structure, wherein each element is of an elastic material that comprises predominantly fire resistant rubber, and wherein at least one of the elements, and preferably each of the elements, exhibits at room temperature a green colour, wherein preferably the sealant also exhibits such a colour, wherein even more preferably the sealant exhibits the same color.
2 A plurality of elements according to paragraph 1, wherein the color is a pastel color.
3 A plurality of elements according to paragraph 2 and/or 3, wherein the color has a calming physiological effect on humans and/or a calming psychological effect on humans.
4 A plurality of elements according to paragraph 1, 2 or 3 wherein the color is a green pastel color.
5 A plurality of elements according to anyone of paragraphs 1-4, wherein at least one of the elements and preferable each element is a longitudinal element.
6 A plurality of elements according to anyone of the previous paragraphs, wherein each element is free of a flange.
7 A plurality of elements according to anyone of the previous paragraphs, wherein each element is a tubular element having a hollow core, or wherein a number of the elements can together form one tubular element having a hollow core.
8 A plurality of elements according to anyone of the previous paragraphs, wherein each element is cylindrical.
9 A plurality of elements according to anyone of the previous paragraphs, wherein each element is formed from an extrudate.
10 A plurality of elements according to anyone of the previous paragraphs, wherein each element is formed by injection moulding.
11 A plurality of elements according to anyone of the previous paragraphs, wherein each element is formed by compression moulding.
12 A plurality of elements according to anyone of the previous paragraphs, wherein each element has an inner diameter in a range of 8 to 40 millimetres, preferably in a range of 10 to 32 millimetres.
13 A plurality of elements according to anyone of the previous paragraphs, wherein each tubular element has an outer diameter in a range of 16 to 50 millimetres, preferably in a range of 20 to 40 millimetres.
14 A plurality of elements according to anyone of the previous paragraphs, wherein each tubular element has a mantle wall having a thickness of about 3 to 7 millimetres, preferably between 4 to 6 millimetres.
15 A plurality of elements according to anyone of the previous paragraphs, wherein the rubber has a hardness in a range of 70 to 79 Shore A, preferably in a range of 72 to 77 Shore A.
16 A plurality of elements according to anyone of the paragraphs 1-9, wherein each, and preferably every, element comprises a foam.
17 A plurality of elements according to paragraph 16, wherein the foam comprises cells, of which preferably more than 60% are closed cells.
18 A plurality of elements according to anyone of the previous paragraphs, wherein the rubber is a silicone rubber.
19 A plurality of elements according to anyone of the previous paragraphs, wherein the rubber is a ceramifiable rubber.
20 A fire resistant sealant for use as part of a fire resistant sealing system for sealing off a conduit by providing a support structure in the conduit using rubber elements and by providing the sealant against that support-structure, wherein the sealant vulcanizes into rubber that exhibits at room temperature and after vulcanization a green color.
21 A sealant according to paragraph 20, wherein the color is a pastel color.
22 A sealant according to paragraph 20 and/or 21, wherein the color has a calming physiological effect on humans and/or a calming psychological effect on humans.
23 A sealant according to paragraph 20, 21 or 22 wherein the color is a green pastel color.
24 A sealant according to any one of paragraphs 20-23, wherein the sealant comprises after vulcanization silicone rubber.

1. A plurality of elements of which each element is for use as part of a fire resistant sealing system for sealing off a conduit by making with the elements a support structure in the conduit, wherein each element is of an elastic material that comprises predominantly fire resistant rubber, and wherein at least one of the elements exhibits at room temperature a color that has a calming physiological effect on humans and/or a calming psychological effect on humans.

2. A plurality of elements according to claim 1, wherein the color is a pastel color.

3. A plurality of elements according to claim 2, wherein the color is a green color.

4. A plurality of elements according to claim 1, wherein the color is a green pastel color.

5. A plurality of elements according to claim 1, wherein at least one of the elements is a longitudinal element.

6. A plurality of elements according to claim 1, wherein each element is free of a flange.

7. A plurality of elements according to claim 1, wherein each element is a tubular element having a hollow core.

8. A plurality of elements according to claim 1, wherein each element is cylindrical.

9. A plurality of elements according to claim 1, wherein each element is formed from an extrudate.

10. A plurality of elements according to claim 1, wherein each element is formed by injection molding.

11. A plurality of elements according to claim 1, wherein each element is formed by compression molding.

12. A plurality of elements according to claim 7, wherein each tubular element has an inner diameter in a range of 8 to 40 millimeters.

13. A plurality of elements according to claim 7, wherein each tubular element has an outer diameter in a range of 16 to 50 millimeters.

14. A plurality of elements according to claim 7, wherein each tubular element has a mantle wall having a thickness in a range of about 3 to 7.

15. A plurality of elements according to claim 1, wherein the rubber has a hardness in a range of 70 to 79 Shore A.

16. A plurality of elements according to claim 1, wherein each element comprises a foam.

17. A plurality of elements according to claim 16, wherein the foam comprises cells, of which more than 60% are closed cells.

18. A plurality of elements according to claim 1, wherein the rubber is a silicone rubber.

19. A plurality of elements according to claim 1, wherein the rubber is a ceramifiable rubber.

20. A fire resistant sealant for use as part of a fire-resistant sealing system for sealing off a conduit by providing a support structure in the conduit using rubber elements and by providing the sealant against that support-structure, wherein the sealant vulcanizes into rubber that exhibits at room temperature, and before and after vulcanization, a color that has a calming physiological effect on humans and/or a calming psychological effect on humans.

21. A sealant according to claim 20, wherein the color is a pastel color.

22. A sealant according to claim 20, wherein the color is a green color.

23. A sealant according to claim 20, wherein the color is a green pastel color.

24. A sealant according to claim 20, wherein the sealant comprises after vulcanization silicone rubber.

25. A plurality of elements according to claim 1, further comprising a sealant provided against the support structure.

26. A plurality of elements according to claim 26, wherein the sealant exhibits a color that has a calming physiological effect on humans and/or a calming psychological effect on humans.

27. A plurality of elements according to claim 25, wherein the sealant exhibits the same color as the at least one of the elements.

28. A plurality of elements according to claim 1, wherein a number of the elements can together form one tubular element having a hollow core.

29. A plurality of elements according to claim 12, wherein the inner diameter is in a range of 10 to 32 millimeters.

30. A plurality of elements according to claim 13, wherein the outer diameter is in a range of 20 to 40 millimeters.

31. A plurality of elements according to claim 14, wherein the mantle wall has a thickness in a range of 4 to 6 millimeters.

32. A plurality of elements according to claim 1, wherein each of the elements exhibits at room temperature a color that has a calming physiological effect on humans and/or a calming psychological effect on humans.

33. A plurality of elements according to claim 15, wherein the rubber has a hardness in a range of 72 to 77 Shore A.
